(19) United States
(12) Patent Application Publication
(10) Pub. No.: US 2026/0044048 A1
(43) Pub. Date: Feb. 12, 2026

(54) WAVELENGTH CONVERSION DEVICE

(71) Applicant: Gigaphoton Inc., Tochigi (JP)

(72) Inventor: Takayuki OSANAI, Tochigi (JP)

(73) Assignee: Gigaphoton Inc., Tochigi (JP)

(21) Appl. No.: 19/257,362

(22) Filed: Jul. 1, 2025

(30) Foreign Application Priority Data
Aug. 8, 2024 (JP) 2024-132439

(51) Int. Cl. G02F 1/35; G02F 1/355

(52) U.S. Cl. CPC G02F 1/3505; G02F 1/354; G02F 1/3551

(57) ABSTRACT

A wavelength conversion device according to an aspect of the present disclosure includes a wavelength conversion crystal configured to wavelength-convert incident light and to output outgoing light, a holder that holds the wavelength conversion crystal on an optical path of the incident light, a cell that houses the wavelength conversion crystal and the holder inside and has a first inlet for supplying a purge gas to the inside and a first outlet for discharging the purge gas from the inside, a first cylindrical member that has an internal space through which the optical path of the incident light passes, and is spaced from the wavelength conversion crystal, and a first partition wall that is disposed between the first inlet and the first outlet and holds the first cylindrical member.

### CROSS-REFERENCE TO RELATED APPLICATIONS

The present application claims the benefit of Japanese Patent Application No. 2024-132439, filed on Aug. 8, 2024, the entire contents of which are hereby incorporated by reference.

### BACKGROUND

### 1. Technical Field

The present disclosure relates to a wavelength conversion device.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation beams of the KrF excimer laser apparatus and the ArF excimer laser apparatus are as wide as from 350 μm to 400 pm. Therefore, when a projection lens is formed of a material that transmits ultraviolet light such as KrF and ArF laser beams, chromatic aberration may occur. As a result, the resolution may decrease. Thus, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (such as etalon or grating) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Documents

Patent Document 1: Japanese Unexamined Patent Application Publication No. 2015-155933
Patent Document 2: Japanese Unexamined Patent Application Publication No. 3-263017
Patent Document 3: Japanese Unexamined Patent Application Publication No. 11-288012

### SUMMARY

A wavelength conversion device according to one aspect of the present disclosure includes a wavelength conversion crystal, a holder, a cell, a first cylindrical member, and a first partition wall. The wavelength conversion crystal is configured to wavelength-convert incident light and to output outgoing light. The holder holds the wavelength conversion crystal on an optical path of the incident light. The cell houses the wavelength conversion crystal and the holder inside and has a first inlet for supplying a purge gas to the inside and a first outlet for discharging the purge gas from the inside. The first cylindrical member has an internal space through which the optical path of the incident light passes, and is spaced from the wavelength conversion crystal. The first partition wall is disposed between the first inlet and the first outlet and holds the first cylindrical member.

### BRIEF DESCRIPTION OF THE DRAWINGS

An embodiment of the present disclosure will be described below, by way of example only, with reference to the accompanying drawings.

FIG. 1 is a diagram schematically illustrating a configuration of a laser system according to a comparative example.

FIG. 2 is a sectional view schematically illustrating a configuration of a wavelength conversion device according to the comparative example.

FIG. 3 is a sectional view schematically illustrating a configuration of a wavelength conversion device according to an embodiment.

FIG. 4 is a sectional view illustrating a cross section along a line A-A in FIG. 3.

FIG. 5 is a sectional view illustrating a cross section along a line B-B in FIG. 3.

FIG. 6 is a sectional view illustrating an example in which a gap is provided between a third partition wall and a holder.

FIG. 7 is a sectional view schematically illustrating a configuration of a wavelength conversion device according to a first modification.

FIG. 8 is a sectional view schematically illustrating a configuration of a wavelength conversion device according to a second modification.

FIG. 9 is a sectional view schematically illustrating a configuration of a wavelength conversion device according to a third modification.

FIG. 10 is a sectional view schematically illustrating a configuration of a wavelength conversion device according to a fourth modification.

FIG. 11 is a sectional view schematically illustrating a configuration of a wavelength conversion device according to a fifth modification.

### DESCRIPTION OF EMBODIMENT

### <Contents>

1. Comparative Example
   1.1 Solid-State Laser System
      1.1.1 Configuration
      1.1.2 Operation
   1.2 Wavelength Conversion Device
   1.3 Problem
2. Embodiment
   2.1 Configuration
   2.2 Operation
   2.3 Advantage
   2.4 Modifications of Wavelength Conversion Device
      2.4.1 First Modification
      2.4.2 Second Modification
      2.4.3 Third Modification
      2.4.4 Fourth Modification
      2.4.5 Fifth Modification

Hereinafter, an embodiment of the present disclosure will be described in detail with reference to the drawings. The embodiment described below show some examples of the present disclosure and do not limit contents of the present disclosure. In addition, all configurations and operations described in the embodiment are not necessarily essential as configurations and operations of the present disclosure. Here, the same components are denoted by the same reference signs, and any redundant description thereof is omitted.

### 1. Comparative Example

First, the comparative example of the present disclosure will be described. The comparative example of the present disclosure is an example recognized by the applicant as known only by the applicant, and is not a publicly known example admitted by the applicant.

### 1.1 Solid-State Laser System

### 1.1.1 Configuration

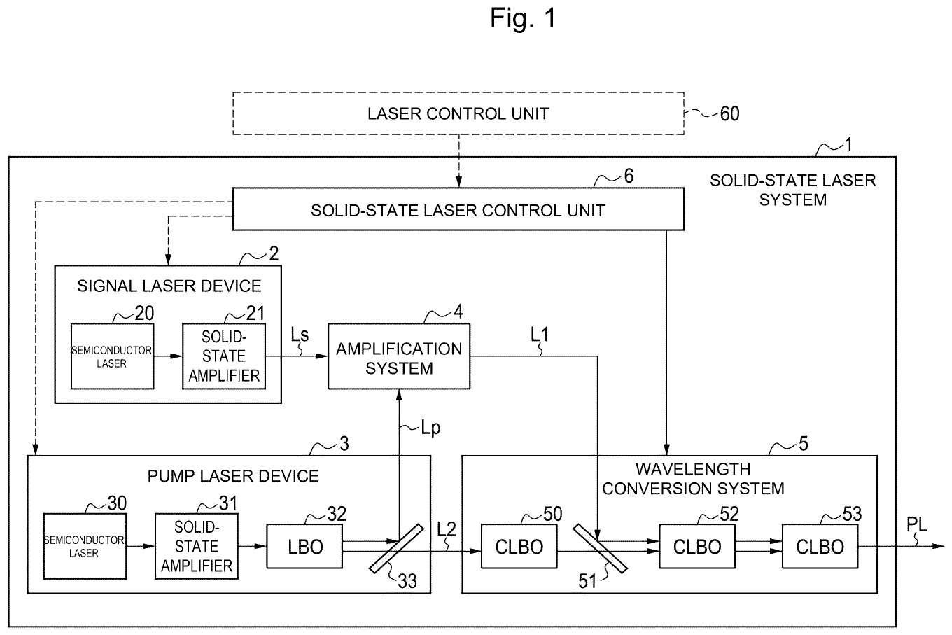

FIG. 1 schematically illustrates a configuration of a solid-state laser system 1 according to the comparative example. The solid-state laser system 1 includes a signal laser device 2, a pump laser device 3, an amplification system 4, a wavelength conversion system 5, and a solid-state laser control unit 6. The solid-state laser system 1 outputs a pulse laser beam PL having a wavelength of about 193.4 nm.

The signal laser device 2 includes a semiconductor laser 20 and a solid-state amplifier 21. The semiconductor laser 20 oscillates in continuous wave (CW) operation with a single longitudinal mode, and outputs a CW laser beam having the wavelength of about 1553 nm. The solid-state amplifier 21 is a semiconductor optical amplifier (SOA) that amplifies the CW laser beam output from the semiconductor laser 20 and outputs the amplified laser beam as a signal laser beam Ls. The signal laser beam Ls output from the signal laser device 2 enters the amplification system 4.

The pump laser device 3 includes a semiconductor laser 30, a solid-state amplifier 31, an LBO (LiB₃O₅) crystal 32, and a dichroic mirror 33. The semiconductor laser 30 oscillates in CW operation with the single longitudinal mode and outputs a CW laser beam having the wavelength of about 1030 nm. The solid-state amplifier 31 includes a semiconductor optical amplifier, a Yb fiber amplifier, and a Yb: YAG crystal, and pulse-amplifies the CW laser beam output from the semiconductor laser 30.

The LBO crystal 32 is disposed in a subsequent stage of the solid-state amplifier 31, wavelength-converts a part of the pulse laser beam having the wavelength of about 1030 nm output from the solid-state amplifier 31 into a second harmonic having the wavelength of about 515 nm, and outputs the second harmonic. The remaining part of the pulse laser beam having the wavelength of about 1030 nm output from the solid-state amplifier 31 is transmitted through the LBO crystal 32 without being wavelength-converted.

The dichroic mirror 33 is disposed in a subsequent stage of the LBO crystal 32, highly reflects the pulse laser beam having the wavelength of about 1030 nm that has transmitted through the LBO crystal 32, and highly transmits the second harmonic output from the LBO crystal 32. The pulse laser beam highly reflected by the dichroic mirror 33 enters the amplification system 4 as a pump laser beam Lp.

The amplification system 4 includes a parametric amplifier (Optical Parametric Amplifier: OPA). For example, the OPA includes a periodically poled lithium niobate crystal (Periodically Poled Lithium Niobate: PPLN) and a periodically poled potassium titanyl phosphate crystal (Periodically Poled KTP: PPKTP). The OPA pulse-amplifies the signal laser beam Ls by the pump laser beam Lp and outputs it as a first pulse laser beam L1.

The wavelength conversion system 5 includes a CLBO (CsLiB₆O₁₀) crystal 50, a dichroic mirror 51, a CLBO crystal 52, and a CLBO crystal 53. The CLBO crystals 50, 52, and 53 are nonlinear optical crystals, and are examples of a “wavelength conversion crystal” according to technology of the present disclosure.

The signal laser beam Ls pulse-amplified in the amplification system 4 enters the wavelength conversion system 5 as the first pulse laser beam L1, and the second harmonic transmitted through the dichroic mirror 33 of the pump laser device 3 enters the wavelength conversion system 5 as a second pulse laser beam L2.

The CLBO crystal 50 is disposed on an optical path of the second pulse laser beam L2, wavelength-converts the incident second pulse laser beam L2 into a fourth harmonic having the wavelength of about 258 nm, and outputs it.

The dichroic mirror 51 is disposed in a subsequent stage of the CLBO crystal 50, and highly transmits the pulse laser beam of the fourth harmonic output from the CLBO crystal 50. The first pulse laser beam L1 output from the amplification system 4 is made incident on the dichroic mirror 51. The dichroic mirror 51 is disposed so that the first pulse laser beam L1 is highly reflected and the first pulse laser beam L1 and the pulse laser beam of the fourth harmonic coaxially enter the CLBO crystal 52.

The CLBO crystal 52 and the CLBO crystal 53 are disposed in series in a subsequent stage of the dichroic mirror 51, and each perform sum frequency generation to generate and output the pulse laser beam PL having the wavelength of about 193.4 nm.

The solid-state laser control unit 6 is formed of a processor and is connected to the signal laser device 2, the pump laser device 3, and the wavelength conversion system 5. An external laser control unit 60 is connected to the solid-state laser control unit 6.

### 1.1.2 Operation

Next, the operation of the solid-state laser system 1 according to the comparative example will be described. First, the solid-state laser control unit 6 operates the pump laser device 3 in response to an instruction from the laser control unit 60. Specifically, the solid-state laser control unit 6 causes the semiconductor laser 30 to output the CW laser beam having the wavelength of about 1030 nm by controlling a current value of the semiconductor laser 30. Next, the solid-state laser control unit 6 pulse-amplifies the CW laser beam by controlling the solid-state amplifier 31.

Consequently, the pulse laser beam having the wavelength of about 1030 nm is output from the solid-state amplifier 31 and enters the LBO crystal 32, and a part of the pulse laser beam is wavelength-converted into the second harmonic by the LBO crystal 32, and the other part of the pulse laser beam is transmitted through the LBO crystal 32. The second harmonic is highly transmitted through the dichroic mirror 33 and enters the wavelength conversion system 5 as the second pulse laser beam L2. The pulse laser beam transmitted through the LBO crystal 32 is highly reflected by the dichroic mirror 33 and enters the amplification system 4 as the pump laser beam Lp.

Next, the solid-state laser control unit 6 operates the signal laser device 2. Specifically, the solid-state laser control unit 6 causes the semiconductor laser 20 to oscillate in CW operation and to output the CW laser beam having the wavelength of about 1553 nm by controlling a current value of the semiconductor laser 20. The CW laser beam output from the semiconductor laser 20 is amplified by the solid-state amplifier 21, is output as the signal laser beam Ls, and enters the amplification system 4.

The signal laser beam Ls that has entered the amplification system 4 is pulse-amplified by the pump laser beam Lp, is output as the first pulse laser beam L1, and enters the wavelength conversion system 5.

The first pulse laser beam L1 that has entered the wavelength conversion system 5 is highly reflected by the dichroic mirror 51 and enters the CLBO crystal 52. Further, the second pulse laser beam L2 that has entered the wavelength conversion system 5 is wavelength-converted into the fourth harmonic by the CLBO crystal 50, is highly transmitted through the dichroic mirror 51, and enters the CLBO crystal 52.

By the sum frequency generation by the first pulse laser beam L1 having the wavelength of about 1553 nm and the fourth harmonic having the wavelength of about 258 nm that have entered the CLBO crystal 52, a first sum frequency beam having the wavelength of about 221 nm is generated. A part of the first pulse laser beam L1 is transmitted through the CLBO crystal 52 and enters the CLBO crystal 53 coaxially with the first sum frequency beam.

By the sum frequency generation by the first pulse laser beam L1 having the wavelength of about 1553 nm and the first sum frequency beam having the wavelength of about 221 nm that have entered the CLBO crystal 53, a second sum frequency beam having the wavelength of about 193.4 nm is generated. The second sum frequency beam is output from the wavelength conversion system 5 as the pulse laser beam PL.

The pulse laser beam PL output from the wavelength conversion system 5 may be amplified by an unillustrated excimer amplifier.

### 1.2 Wavelength Conversion Device

Since the CLBO crystals 50, 52, and 53 each have a deliquescence property, they are disposed inside a cell purged with a purge gas so that a surrounding atmosphere is low-humidity atmosphere. Hereinafter, a device including the cell housing the wavelength conversion crystal such as the CLBO crystals 50, 52, and 53 is referred to as the “wavelength conversion device”.

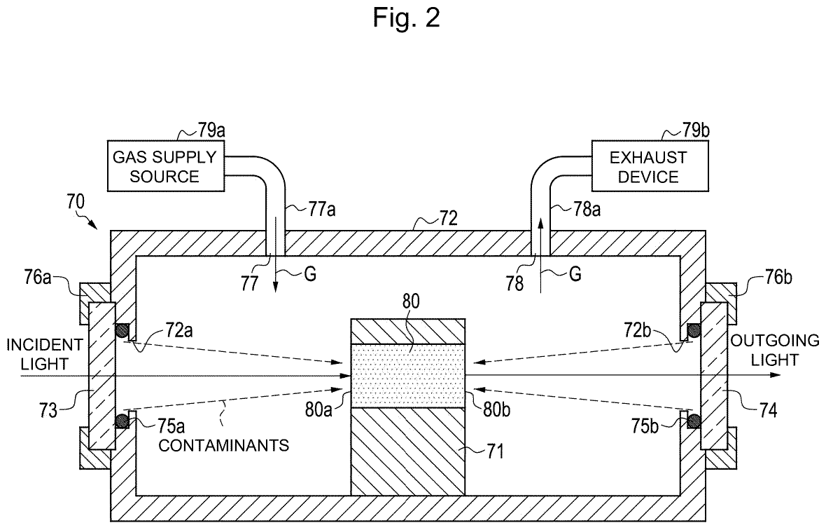

FIG. 2 schematically illustrates a configuration of a wavelength conversion device 70 according to the comparative example. The wavelength conversion device 70 includes a wavelength conversion crystal 80, a holder 71 that holds the wavelength conversion crystal 80, and a cell 72 that houses the holder 71. The wavelength conversion crystal 80 is one of the CLBO crystals 50, 52, and 53.

The cell 72 is, for example, a sealed container made of aluminum or stainless steel (SUS). In the present comparative example, the cell 72 has a rectangular parallelepiped shape. The holder 71 is fixed to an inner bottom surface of the cell 72. The holder 71 may be provided with an adjustment mechanism that enables adjustment of a disposition angle of the wavelength conversion crystal 80.

In the cell 72, an entrance side opening 72a is formed on an optical path of incident light entering the wavelength conversion crystal 80. Further, in the cell 72, an exit side opening 72b is formed on an optical path of outgoing light output from the wavelength conversion crystal 80. The entrance side opening 72a and the exit side opening 72b are formed at positions opposed to each other with the wavelength conversion crystal 80 interposed therebetween. For example, when the wavelength conversion crystal 80 is the CLBO crystal 50, the incident light is the second pulse laser beam L2 and the outgoing light is the fourth harmonic.

The incident light is made incident on an entrance side end face 80a of the wavelength conversion crystal 80. The outgoing light is output from an exit side end face 80b of the wavelength conversion crystal 80. Hereinafter, the entrance side end face 80a and the exit side end face 80b may be simply referred to as “a surface of the wavelength conversion crystal 80”.

An entrance window 73 is provided so as to cover the entrance side opening 72a. Further, an exit window 74 is provided so as to cover the exit side opening 72b. The entrance window 73 and the exit window 74 are formed by coating an unillustrated reflection suppressing film on both surfaces of a substrate formed of a calcium fluoride (CaF₂) crystal or synthetic quartz. The entrance window 73 transmits the incident light, allowing it to enter the wavelength conversion crystal 80. The exit window 74 transmits the outgoing light output from the wavelength conversion crystal 80.

The entrance window 73 is fixed to the cell 72 via an O-ring 75a for ensuring airtightness. Specifically, the O-ring 75a is disposed between the entrance window 73 and the cell 72. The entrance window 73 is held by a window holder 76a, and the window holder 76a is fixed to the cell 72 with unillustrated bolts or the like.

The exit window 74 is fixed to the cell 72 via an O-ring 75b for ensuring airtightness. Specifically, the O-ring 75b is disposed between the exit window 74 and the cell 72. The exit window 74 is held by a window holder 76b, and the window holder 76b is fixed to the cell 72 with unillustrated bolts or the like.

The O-ring refers to an annular sealing member having a substantially circular cross section. For example, the O-rings 75a and 75b are resin rings formed of Teflon (R), rubber, or the like.

In the cell 72, an inlet 77 for introducing a purge gas G into the cell 72 and an outlet 78 for discharging the purge gas G to an outside of the cell 72 are formed. For example, the inlet 77 is disposed on a light entrance side of the wavelength conversion crystal 80, and the outlet 78 is disposed on a light exit side of the wavelength conversion crystal 80. The purge gas is a gas such as N₂, CO₂, Ar, O₂, or CDA (Clean dry air).

To the inlet 77, a gas introduction pipe 77a for introducing the purge gas G supplied from a gas supply source 79a such as a cylinder is connected. To the outlet 78, a gas discharge pipe 78a for discharging the purge gas G by an exhaust device 79b such as a pump is connected. An end portion of the gas discharge pipe 78a may be an open end and unconnected to the exhaust device 79b.

### 1.3 Problem

The present applicant has found that, in the wavelength conversion device 70 according to the comparative example, contaminants presumed to be derived from the O-rings 75a and 75b adhere to the surface of the wavelength conversion crystal 80. Specifically, contaminants such as fluoride and hydrocarbons adhere to the surface of the wavelength conversion crystal 80. As a result, power of the outgoing light of the wavelength conversion crystal 80 decreases and a profile of the outgoing light deteriorates, thereby deteriorating wavelength conversion efficiency in the wavelength conversion crystal in the subsequent stage. When the wavelength conversion crystal 80 is contaminated in this way, utilization efficiency of light is lowered, so that the wavelength conversion crystal 80 needs to be replaced. Since the wavelength conversion crystal 80 is expensive, it is not preferable to replace it frequently.

Therefore, an object of the present disclosure is to reduce adhesion of contaminants onto the surface of the wavelength conversion crystal 80.

### 2. Embodiment

### 2.1 Configuration

The solid-state laser system 1 according to an embodiment of the present disclosure has the same configuration as the solid-state laser system 1 according to the comparative example except that the configuration of the wavelength conversion device 70 is different.

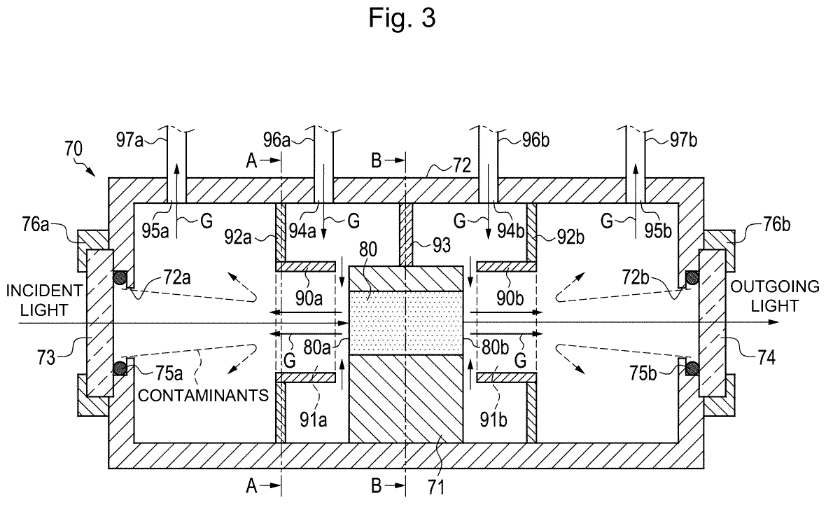

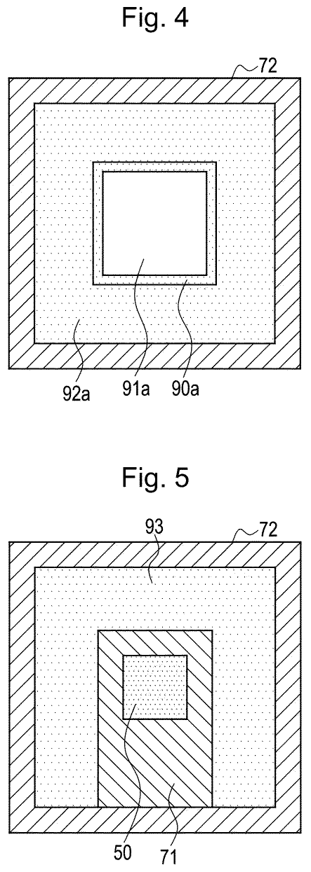

FIG. 3 schematically illustrates a configuration of the wavelength conversion device 70 according to the embodiment. FIG. 4 illustrates a cross section along a line A-A in FIG. 3. FIG. 5 illustrates a cross section along a line B-B in FIG. 3.

In the present embodiment, a first cylindrical member 90a, a second cylindrical member 90b, a first partition wall 92a, a second partition wall 92b, and a third partition wall 93 are provided inside the cell 72. The first cylindrical member 90a and the first partition wall 92a are disposed on the light entrance side of the wavelength conversion crystal 80. The second cylindrical member 90b and the second partition wall 92b are disposed on the light exit side of the wavelength conversion crystal 80.

Each of the first cylindrical member 90a and the second cylindrical member 90b has a rectangular cylindrical shape or a cylindrical shape. In the present embodiment, each of the first cylindrical member 90a and the second cylindrical member 90b is a rectangular tube having a rectangular cross section.

The first cylindrical member 90a is disposed such that the optical path of the incident light entering the wavelength conversion crystal 80 passes through an internal space 91a of the first cylindrical member 90a, and an end portion is spaced from the entrance side end face 80a of the wavelength conversion crystal 80 by a predetermined distance. The second cylindrical member 90b is disposed such that the optical path of the outgoing light output from the wavelength conversion crystal 80 passes through an internal space 91b of the second cylindrical member 90b, and an end portion is spaced from the exit side end face 80b of the wavelength conversion crystal 80 by a predetermined distance.

The first partition wall 92a holds the first cylindrical member 90a and is connected to an inner wall of the cell 72. Specifically, as illustrated in FIG. 4, the first partition wall 92a is connected to an outer periphery of the first cylindrical member 90a and partitions a space on an outer side of the first cylindrical member 90a in the cell 72. In the present embodiment, the first partition wall 92a is connected to the end portion of the first cylindrical member 90a on a side opposite to the wavelength conversion crystal 80.

Similarly, the second partition wall 92b holds the second cylindrical member 90b and is connected to the inner wall of the cell 72. Specifically, the second partition wall 92b is connected to an outer periphery of the second cylindrical member 90b and partitions a space on an outer side of the second cylindrical member 90b in the cell 72. In the present embodiment, the second partition wall 92b is connected to the end portion of the second cylindrical member 90b on a side opposite to the wavelength conversion crystal 80.

The third partition wall 93 defines a space on the light entrance side and a space on the light exit side of the wavelength conversion crystal 80 in the cell 72. Specifically, as illustrated in FIG. 5, the third partition wall 93 is connected between an outer periphery of the holder 71 and the inner wall of the cell 72.

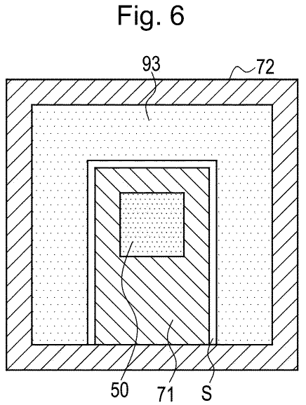

In a case where the holder 71 is provided with the adjustment mechanism, as illustrated in FIG. 6, a gap S for allowing movement by the adjustment mechanism may be provided between the third partition wall 93 and the holder 71.

Further, in the present embodiment, the cell 72 is provided with a first inlet 94a, a second inlet 94b, a first outlet 95a, and a second outlet 95b in place of the inlet 77 and the outlet 78 of the comparative example.

A gas introduction pipe 96a is connected to the first inlet 94a, and a gas supply source similar to the gas supply source 79a is connected to the gas introduction pipe 96a. A gas introduction pipe 96b is connected to the second inlet 94b, and a gas supply source similar to the gas supply source 79a is connected to the gas introduction pipe 96b. A common gas supply source may be connected to the gas introduction pipe 96a and the gas introduction pipe 96b.

A gas discharge pipe 97a is connected to the first outlet 95a, and an exhaust device similar to the exhaust device 79b is connected to the gas discharge pipe 97a. A gas discharge pipe 97b is connected to the second outlet 95b, and an exhaust device similar to the exhaust device 79b is connected to the gas discharge pipe 97b. A common exhaust device may be connected to the gas discharge pipe 97a and the gas discharge pipe 97b. Further, respective end portions of the gas discharge pipe 97a and the gas discharge pipe 97b may be open ends and unconnected to the exhaust device.

The first inlet 94a and the first outlet 95a are disposed on the light entrance side of the wavelength conversion crystal 80. The second inlet 94b and the second outlet 95b are disposed on the light exit side of the wavelength conversion crystal 80.

In addition, the first inlet 94a is disposed at a position closer to the wavelength conversion crystal 80 than the first outlet 95a. That is, the first outlet 95a is disposed more on the light entrance side than the first inlet 94a. The second inlet 94b is disposed at a position closer to the wavelength conversion crystal 80 than the second outlet 95b. That is, the second outlet 95b is disposed more on the light exit side than the second inlet 94b.

The first partition wall 92a is disposed between the first inlet 94a and the first outlet 95a. As a result, the purge gas G introduced into the cell 72 from the first inlet 94a passes through the internal space 91a of the first cylindrical member 90a toward the first outlet 95a. The second partition wall 92b is disposed between the second inlet 94b and the second outlet 95b. As a result, the purge gas G introduced into the cell 72 from the second inlet 94b passes through the internal space 91b of the second cylindrical member 90b toward the second outlet 95b.

The other configuration of the wavelength conversion device 70 according to the present embodiment is the same as that of the comparative example.

### 2.2 Operation

The operation of the solid-state laser system 1 according to the present embodiment is the same as that of the comparative example except that an effect of the wavelength conversion device 70 is different. Hereinafter, the effect of the wavelength conversion device 70 will be described.

In the present embodiment, the purge gas G introduced into the cell 72 from the first inlet 94a passes between the end portion of the first cylindrical member 90a and the end portion of the wavelength conversion crystal 80, and flows along the entrance side end face 80a of the wavelength conversion crystal 80. Thereafter, the purge gas G passes through the internal space 91a of the first cylindrical member 90a from a side of the wavelength conversion crystal 80 toward a side of the entrance window 73, and is directed toward the first outlet 95a. Therefore, the contaminants generated from the O-ring 75a near the entrance window 73 are discharged from the first outlet 95a together with the purge gas G.

In the present embodiment, the purge gas G introduced into the cell 72 from the second inlet 94b passes between the end portion of the second cylindrical member 90b and the end portion of the wavelength conversion crystal 80, and flows along the exit side end face 80b of the wavelength conversion crystal 80. Thereafter, the purge gas G passes through the internal space 91b of the second cylindrical member 90b from the side of the wavelength conversion crystal 80 toward the side of the exit window 74, and is directed toward the second outlet 95b. Therefore, the contaminants generated from the O-ring 75b near the exit window 74 are discharged from the second outlet 95b together with the purge gas G.

In the present embodiment, since the third partition wall 93 that defines the space on the light entrance side and the space on the light exit side in the cell 72 is provided, a flow rate of the purge gas G can be made different between the light entrance side and the light exit side. For example, the flow rate on the light exit side, where the outgoing light having a shorter wavelength than the incident light is output, may be higher than the flow rate on the light entrance side.

### 2.3 Advantage

In the present embodiment, since the purge gas G flows in a direction of separating from the surface of the wavelength conversion crystal 80, the contaminants are suppressed from reaching the surface of the wavelength conversion crystal 80. This reduces adhesion of the contaminants to the surface of the wavelength conversion crystal 80. As a result, a decrease in the power of the outgoing light of the wavelength conversion crystal 80 and a deterioration in the profile are suppressed, so that lifetime of the wavelength conversion crystal 80 is prolonged and frequent replacement of the wavelength conversion crystal 80 becomes unnecessary.

### 2.4 Modifications of Wavelength Conversion Device

Hereinafter, various modifications of the wavelength conversion device 70 according to the embodiment will be described.

### 2.4.1 First Modification

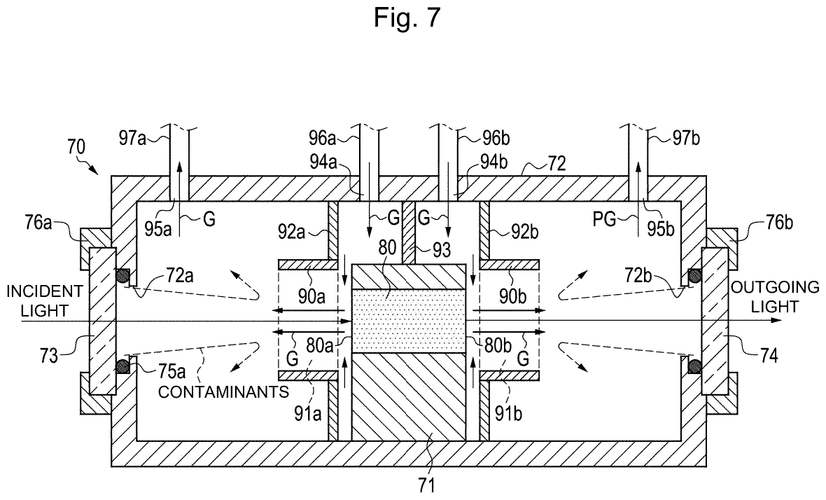

FIG. 7 schematically illustrates a configuration of a wavelength conversion device 70 according to a first modification. The wavelength conversion device 70 according to the present modification differs from the wavelength conversion device 70 according to the embodiment only in a connecting position of the first partition wall 92a to the first cylindrical member 90a and a connecting position of the second partition wall 92b to the second cylindrical member 90b.

While the first partition wall 92a is connected to the end portion of the first cylindrical member 90a on a side opposite to the wavelength conversion crystal 80 in the embodiment, the first partition wall 92a is connected to the end portion of the first cylindrical member 90a on a side of the wavelength conversion crystal 80 in the present modification. Similarly, while the second partition wall 92b is connected to the end portion of the second cylindrical member 90b on a side opposite to the wavelength conversion crystal 80 in the embodiment, the second partition wall 92b is connected to the end portion of the second cylindrical member 90b on a side of the wavelength conversion crystal 80 in the present modification.

In the present modification as well, the same effects and advantages as those of the embodiment can be obtained.

### 2.4.2 Second Modification

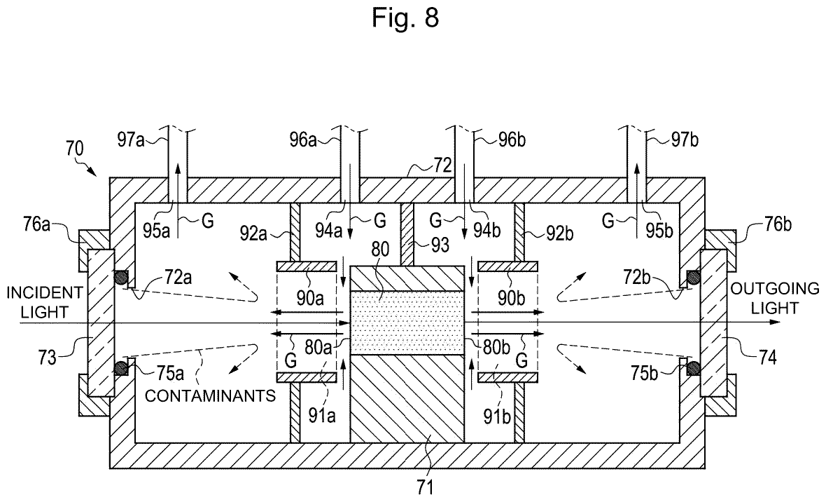

FIG. 8 schematically illustrates a configuration of a wavelength conversion device 70 according to a second modification. The wavelength conversion device 70 according to the present modification differs from the wavelength conversion device 70 according to the embodiment only in the connecting position of the first partition wall 92a to the first cylindrical member 90a and the connecting position of the second partition wall 92b to the second cylindrical member 90b, similarly to the first modification.

In the present modification, the first partition wall 92a is connected between the end portion of the first cylindrical member 90a on a side of the wavelength conversion crystal 80 and the end portion of the first cylindrical member 90a on a side opposite to the wavelength conversion crystal 80. The connecting position of the first partition wall 92a to the first cylindrical member 90a may be any position between the end portion on the side of the wavelength conversion crystal 80 and the end portion on the side opposite to the wavelength conversion crystal 80.

Similarly, in the present modification, the second partition wall 92b is connected between the end portion of the second cylindrical member 90b on a side of the wavelength conversion crystal 80 and the end portion of the second cylindrical member 90b on a side opposite to the wavelength conversion crystal 80. The connecting position of the second partition wall 92b to the second cylindrical member 90b may be any position between the end portion on the side of the wavelength conversion crystal 80 and the end portion on the side opposite to the wavelength conversion crystal 80.

In the present modification as well, the same effects and advantages as those of the embodiment can be obtained.

### 2.4.3 Third Modification

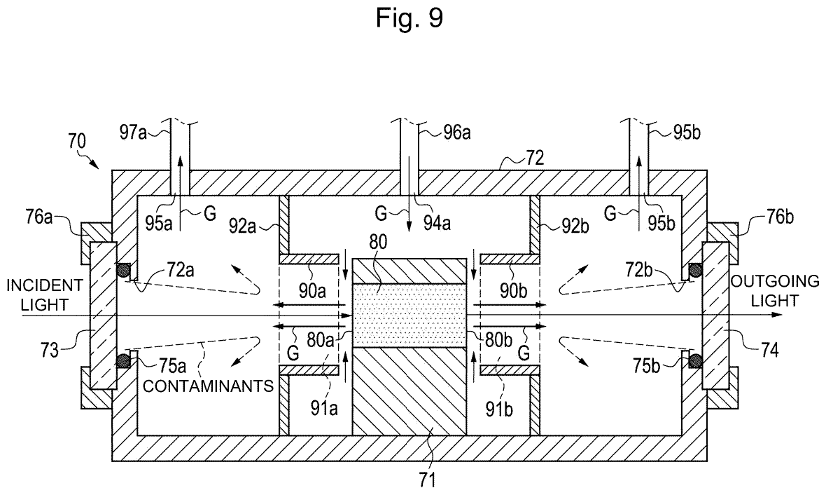

FIG. 9 schematically illustrates a configuration of a wavelength conversion device 70 according to a third modification. The wavelength conversion device 70 according to the present modification is different from the wavelength conversion device 70 according to the embodiment in that the third partition wall 93 is not provided. That is, in the present modification, the space on the light entrance side and the space on the light exit side of the wavelength conversion crystal 80 communicate with each other. Therefore, in the present modification, only the first inlet 94a out of the first inlet 94a and the second inlet 94b is provided. That is, in the present modification, the second partition wall 92b is disposed between the first inlet 94a and the second outlet 95b. In this case, the first inlet 94a is preferably disposed directly above the wavelength conversion crystal 80, that is, at a boundary between the space on the light entrance side and the space on the light exit side.

In the present modification as well, the same effects and advantages as those of the embodiment can be obtained. Further, in the present modification, since the third partition wall 93 and the second inlet 94b are not provided, the configuration of the wavelength conversion device 70 is simplified and a manufacturing cost is reduced.

While the connecting position of the first partition wall 92a to the first cylindrical member 90a and the connecting position of the second partition wall 92b to the second cylindrical member 90b are the same positions as in the embodiment in the present modification, they may be the positions described in the first modification or the second modification.

### 2.4.4 Fourth Modification

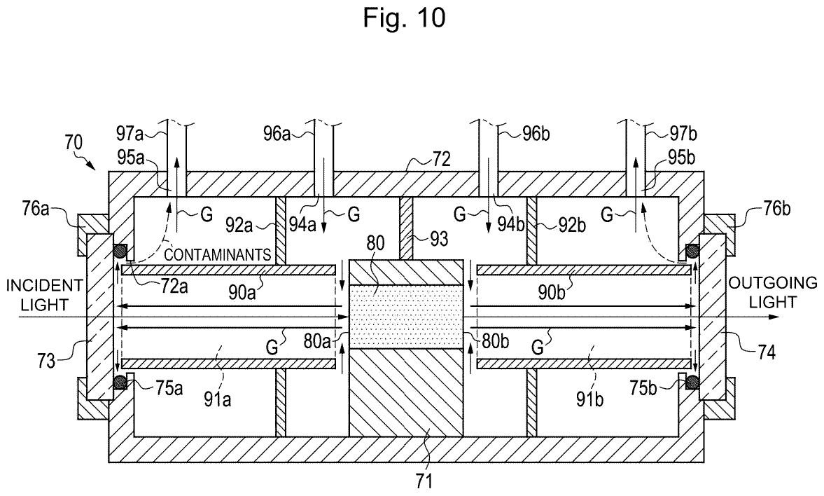

FIG. 10 schematically illustrates a configuration of a wavelength conversion device 70 according to a fourth modification. The wavelength conversion device 70 according to the present modification differs from the wavelength conversion device 70 according to the embodiment only in the configurations of the first cylindrical member 90a and the second cylindrical member 90b.

In the present modification, the end portion of the first cylindrical member 90a on a side opposite to the wavelength conversion crystal 80 extends more to the side of the entrance window 73 than the first outlet 95a. Specifically, the end portion of the first cylindrical member 90a is proximate to the entrance window 73 and is spaced from the entrance window 73 and the cell 72. The end portion of the first cylindrical member 90a preferably extends to a space on the inner side of the O-ring 75a. A surface of the entrance window 73 that the end portion of the first cylindrical member 90a faces is positioned on the inner side of the O-ring 75a. For example, when the first cylindrical member 90a is cylindrical, its outer diameter is smaller than an inner diameter of the O-ring 75a.

In the present modification, the end portion of the second cylindrical member 90b on a side opposite to the wavelength conversion crystal 80 extends more to the side of the exit window 74 than the second outlet 95b. Specifically, the end portion of the second cylindrical member 90b is proximate to the exit window 74 and is spaced from the exit window 74 and the cell 72. The end portion of the second cylindrical member 90b preferably extends to a space on the inner side of the O-ring 75b. A surface of the exit window 74 that the end portion of the second cylindrical member 90b faces is positioned on the inner side of the O-ring 75b. For example, when the second cylindrical member 90b is cylindrical, its outer diameter is smaller than an inner diameter of the O-ring 75b.

The first partition wall 92a may be disposed between the first inlet 94a and the first outlet 95a. The second partition wall 92b may be disposed between the second inlet 94b and the second outlet 95b.

In the present modification, the purge gas G introduced into the cell 72 from the first inlet 94a passes between the end portion of the first cylindrical member 90a and the end portion of the wavelength conversion crystal 80, and flows along the entrance side end face 80a of the wavelength conversion crystal 80. Thereafter, the purge gas G passes through the internal space 91a of the first cylindrical member 90a from the side of the wavelength conversion crystal 80 toward the side of the entrance window 73, and hits the surface of the entrance window 73. The purge gas G that has hit the surface of the entrance window 73 forms a flow toward an outer periphery side of the entrance window 73, and passes through the gap formed among the first cylindrical member 90a, the entrance window 73, and the cell 72 toward the first outlet 95a. Therefore, even if contaminants are generated from the O-ring 75a near the entrance window 73, the contaminants are discharged from the first outlet 95a together with the purge gas G.

In the present modification, the purge gas G introduced into the cell 72 from the second inlet 94b passes between the end portion of the second cylindrical member 90b and the end portion of the wavelength conversion crystal 80, and flows along the exit side end face 80b of the wavelength conversion crystal 80. Thereafter, the purge gas G passes through the internal space 91b of the second cylindrical member 90b from the side of the wavelength conversion crystal 80 toward the side of the exit window 74, and hits the surface of the exit window 74. The purge gas G that has hit the exit window 74 forms a flow toward an outer periphery side of the exit window 74, and passes through the gap formed among the second cylindrical member 90b, the exit window 74, and the cell 72 toward the second outlet 95b. Therefore, the contaminants generated from the O-ring 75b near the exit window 74 are discharged from the second outlet 95b together with the purge gas G.

In the present modification as well, the same effects and advantages as those of the embodiment can be obtained. Further, in the present modification, since the clean purge gas G continues to flow on the surfaces of the entrance window 73 and the exit window 74 respectively, the contaminants generated from the O-rings 75a and 75b are less likely to reach the surfaces, and the adhesion of the contaminants is suppressed. As a result, a decrease in a light transmittance of the entrance window 73 and the exit window 74 is suppressed.

Note that the wavelength conversion device 70 according to the present modification also does not have to be provided with the third partition wall 93 and the second inlet 94b, as described in the third modification. In this case, the first inlet 94a is preferably disposed directly above the wavelength conversion crystal 80, that is, at the boundary between the space on the light entrance side and the space on the light exit side.

### 2.4.5 Fifth Modification

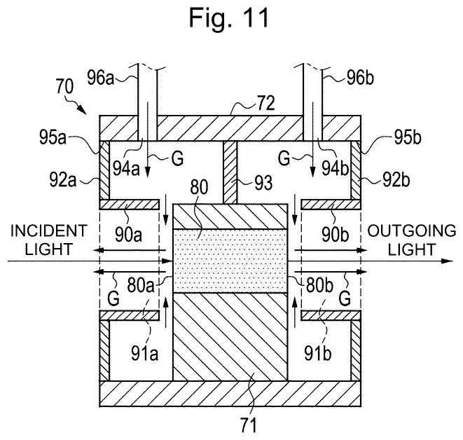

FIG. 11 schematically illustrates a configuration of a wavelength conversion device 70 according to a fifth modification. The wavelength conversion device 70 according to the present modification differs from the wavelength conversion device 70 according to the embodiment in the configuration of the cell 72.

In the present modification, the cell 72 is not provided with the entrance window 73 and the exit window 74. Therefore, the cell 72 is not provided with the O-rings 75a and 75b and the window holders 76a and 76b. In the present modification, the cell 72 has a cylindrical shape, and an end portion on the light entrance side and an end portion on the light exit side are respectively opened. In the present modification, an opening on the entrance side of the cell 72 is the first outlet 95a, and an opening on the exit side of the cell 72 is the second outlet 95b. In the present modification, the gas discharge pipes 97a and 97b are not provided.

The configurations of the first cylindrical member 90a, the second cylindrical member 90b, the first partition wall 92a, the second partition wall 92b, and the third partition wall 93 according to the present modification are the same as those of the embodiment.

Therefore, in the present modification, the first outlet 95a is disposed on the optical path of the incident light entering the wavelength conversion crystal 80, and the second outlet 95b is disposed on the optical path of the outgoing light output from the wavelength conversion crystal 80. Further, in the present modification, an opening of the first cylindrical member 90a on a side opposite to the wavelength conversion crystal 80 is included in the first outlet 95a, and an opening of the second cylindrical member 90b on a side opposite to the wavelength conversion crystal 80 is included in the second outlet 95b.

In the present modification, the purge gas G introduced into the cell 72 from the first inlet 94a passes between the end portion of the first cylindrical member 90a and the end portion of the wavelength conversion crystal 80, and flows along the entrance side end face 80a of the wavelength conversion crystal 80. Thereafter, the purge gas G flows through the internal space 91a of the first cylindrical member 90a to the side opposite to the wavelength conversion crystal 80, and is discharged from the first outlet 95a.

In the present modification, the purge gas G introduced into the cell 72 from the second inlet 94b passes between the end portion of the second cylindrical member 90b and the end portion of the wavelength conversion crystal 80, and flows along the exit side end face 80b of the wavelength conversion crystal 80. Thereafter, the purge gas G flows through the internal space 91b of the second cylindrical member 90b to the side opposite to the wavelength conversion crystal 80, and is discharged from the second outlet 95b.

In the present modification, since the cell 72 is not provided with the O-rings 75a and 75b, the contaminants caused by the O-rings 75a and 75b do not adhere to the surface of the wavelength conversion crystal 80. In addition, in the present modification, although the cell 72 is not sealed, since the purge gas G flows in a direction of separating from the surface of the wavelength conversion crystal 80, moisture and impurities are suppressed from reaching the surface of the wavelength conversion crystal 80, and the periphery of the wavelength conversion crystal 80 is maintained at a low humidity.

Further, in the present modification, since the cell 72 is not provided with the entrance window 73 and the exit window 74, the decrease in the light transmittance due to the deterioration of the entrance window 73 and the exit window 74 does not occur. In addition, in the present modification, since the entrance window 73 and the exit window 74 that are expensive are unnecessary, the configuration of the wavelength conversion device 70 is simplified, and the manufacturing cost is reduced.

Note that the wavelength conversion device 70 according to the present modification also does not have to be provided with the third partition wall 93 and the second inlet 94b, as described in the third modification. In this case, the first inlet 94a is preferably disposed directly above the wavelength conversion crystal 80, that is, at the boundary between the space on the light entrance side and the space on the light exit side.

Further, in the embodiment and the respective modifications, a first structure including the first cylindrical member 90a, the first partition wall 92a, the first inlet 94a, and the first outlet 95a is provided on the light entrance side of the wavelength conversion crystal 80, and a second structure including the second cylindrical member 90b, the second partition wall 92b, the second inlet 94b, and the second outlet 95b is provided on the light exit side of the wavelength conversion crystal 80. It is not necessary to provide both the first structure and the second structure, and only one of the first structure and the second structure may be provided.

The description above is intended to be illustrative and the present disclosure is not limited thereto. Therefore, it would be obvious to those skilled in the art that various modifications to the embodiment of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.”

The description above is intended to be illustrative and the present disclosure is not limited thereto. Therefore, it would be obvious to those skilled in the art that various modifications to the embodiment of the present disclosure would be possible without departing from the spirit and the scope of the appended claims. Further, it would be also obvious to those skilled in the art that embodiment of the present disclosure would be appropriately combined. The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A wavelength conversion device comprising:
a wavelength conversion crystal configured to wavelength-convert incident light and to output outgoing light;
a holder that holds the wavelength conversion crystal on an optical path of the incident light;
a cell that houses the wavelength conversion crystal and the holder inside and has a first inlet for supplying a purge gas to the inside and a first outlet for discharging the purge gas from the inside;
a first cylindrical member that has an internal space and is spaced from the wavelength conversion crystal, the optical path of the incident light passing through the internal space; and
a first partition wall that is disposed between the first inlet and the first outlet and holds the first cylindrical member.

2. The wavelength conversion device according to claim 1, wherein
the first inlet is disposed at a position closer to the wavelength conversion crystal than the first outlet.

3. The wavelength conversion device according to claim 1, wherein
the purge gas flows in the internal space of the first cylindrical member in a direction of separating from the wavelength conversion crystal.

4. The wavelength conversion device according to claim 1, wherein
the cell has a second outlet for discharging the purge gas from the inside,
the first outlet is disposed on a light entrance side of the wavelength conversion crystal, and the second outlet is disposed on a light exit side of the wavelength conversion crystal.

5. The wavelength conversion device according to claim 4, further comprising:
a second cylindrical member that has an internal space and is spaced from the wavelength conversion crystal, an optical path of the outgoing light passing through the internal space; and
a second partition wall that is disposed between the first inlet and the second outlet and holds the second cylindrical member.

6. The wavelength conversion device according to claim 5, wherein
the purge gas flows in the internal space of the second cylindrical member in a direction of separating from the wavelength conversion crystal.

7. The wavelength conversion device according to claim 5, further comprising
a third partition wall that defines a space on the light entrance side and a space on the light exit side of the wavelength conversion crystal in the inside.

8. The wavelength conversion device according to claim 7, wherein
the third partition wall is connected between an outer periphery of the holder and an inner wall of the cell.

9. The wavelength conversion device according to claim 7, wherein
the third partition wall is disposed between an outer periphery of the holder and an inner wall of the cell, and
a gap is provided between the third partition wall and the holder.

10. The wavelength conversion device according to claim 7, wherein
the cell has a second inlet for supplying the purge gas to the inside,
the first inlet is disposed in a space on the light entrance side and the second inlet is disposed in a space on the light exit side, and
the second partition wall is disposed between the second inlet and the second outlet.

11. The wavelength conversion device according to claim 10, wherein
the second inlet is disposed at a position closer to the wavelength conversion crystal than the second outlet.

12. The wavelength conversion device according to claim 11, wherein
the purge gas flows in the internal space of the second cylindrical member in a direction of separating from the wavelength conversion crystal.

13. The wavelength conversion device according to claim 5, wherein
an entrance window disposed on the optical path of the incident light and an exit window disposed on the optical path of the outgoing light are fixed to the cell via respective O-rings.

14. The wavelength conversion device according to claim 13, wherein
an end portion of the first cylindrical member on a side opposite to the wavelength conversion crystal extends closer to a side of the entrance window than the first outlet, and
an end portion of the second cylindrical member on a side opposite to the wavelength conversion crystal extends closer to a side of the exit window than the second outlet.

15. The wavelength conversion device according to claim 14, wherein
the end portion of the first cylindrical member on the side opposite to the wavelength conversion crystal is proximate to the entrance window and is spaced from the entrance window and the cell, and
the end portion of the second cylindrical member on the side opposite to the wavelength conversion crystal is proximate to the exit window and is spaced from the exit window and the cell.

16. The wavelength conversion device according to claim 5, wherein
the first outlet is disposed on the optical path of the incident light, and the second outlet is disposed on the optical path of the outgoing light.
